(19) United States
(12) Patent Application Publication
(10) Pub. No.: US 2025/0019626 A1
(43) Pub. Date: Jan. 16, 2025

(54) IMPROVED BEVERAGE PRODUCTION PROCESS

(71) Applicant: DSM IP Assets B.V., Heerlen (NL)

(72) Inventors: Loes Elizabeth BEVERS, Echt (NL); Theodorus Adolf WIJSMAN, Echt (NL)

(21) Appl. No.: 18/713,222

(22) PCT Filed: Nov. 29, 2022
(86) PCT No.: PCT/EP2022/083681

§ 371 Date: May 24, 2024

(30) Foreign Application Priority Data
Nov. 30, 2021 (EP) EP21211367.4

(51) Int. Cl. C12C 5/00; A23L 2/38; A23L 2/84; C12C 7/20; C12C 11/00; C12C 12/04

(52) U.S. Cl. CPC C12C 5/004; A23L 2/382; A23L 2/84; C12C 7/20; C12C 11/003; C12C 12/04

(57) ABSTRACT

The present invention relates to a process for the prevention or reduction of haze in a beverage by the addition of an endoprotease.

### FIELD OF THE INVENTION

The present invention generally relates to the fields of enzymology and beverage production. Particularly, the present invention relates to processes for the prevention or reduction of haze in a beverage. More particularly, the present invention relates to enzymes and their use in processes for the prevention or reduction of haze in a beverage.

### BACKGROUND OF THE INVENTION

Haze is a well-known phenomenon in the beverage industry. Haze can for example be present in beer, wine and fruit juice. Haze formation can occur at different stages during the production process of a beverage. It is often the result of interactions between proteins and polyphenolic compounds. Haze formation is undesirable because the cloudiness caused by haze formation is considered a quality defect and is perceived negative because consumers expect a clear beverage.

Proline-specific endoprotease have been proposed to prevent or reduce haze formation. These proteases are added during the fermentation step of beverage production processes where they selectively hydrolyse the haze-active, proline-rich proteins thereby preventing the precipitation of protein-polyphenol complexes and thus haze formation. However, in production processes wherein only a limited fermentation step or no fermentation step is applied haze formation is still a problem.

Therefore, still a need remains in the art to provide improved processes for preventing or reducing haze formation in a beverage.

### SUMMARY OF THE INVENTION

An object of the invention is a process for the prevention or reduction of haze in a beverage by using enzymes. Optimization and improvement lie inter alia in the application of the enzymes, especially addition of the enzymes to the wort and incubation of the wort.

### DETAILED DESCRIPTION OF THE INVENTION

Throughout the present specification and the accompanying claims, the words “comprise” and “include” and variations such as “comprises”, “comprising”, “includes” and “including” are to be interpreted inclusively. That is, these words are intended to convey the possible inclusion of other elements or integers not specifically recited, where the context allows. The articles “a” and “an” are used herein to refer to one or to more than one (i.e. to one or at least one) of the grammatical object of the article. By way of example, “an element” may mean one element or more than one element. As will be apparent to those of skill in the art upon reading this application, each of the individual embodiments described and illustrated herein has discrete components and features which may be readily separated from or combined with the features of any of the other embodiments without departing from the scope or spirit of the present invention described herein. Any recited process can be carried out in the order of events recited or in any other order which is logically possible.

The present invention relates to a process for the prevention or reduction of haze in a beverage, the process comprising the steps of (a) preparing a wort, (b) adding a prolyl-specific endoprotease to the wort and incubating the wort, (c) boiling the wort, and (d) preparing the beverage from the wort.

In an embodiment the beverage is a beverage comprising haze sensitive proteins. The beverage may be beer, a malted beverage, an unmalted beverage, wine or fruit juice. In a preferred embodiment the beverage is beer or a malted beverage. In a more preferred, embodiment the beverage is beer.

The term “beer” as used herein is intended to cover beer prepared from mashes prepared from unmalted cereals as well as from mashes prepared from malted cereals and all mashes prepared from a mixture of malted and unmalted cereals. The term “beer” also covers beers prepared with adjuncts and beers with all possible alcohol contents.

The term “malted beverage” as used herein means a beverage in which at least malts are used as raw materials. The malts may be fermented by a yeast or may not be fermented by a yeast.

In a preferred embodiment the beer is alcohol-low beer or alcohol-free beer.

The term “alcohol-free beer” and “non-alcoholic beer” can be used interchangeably. They are defined by beer that has less than 0.5% alcohol by volume (ABV).

The term “alcohol-low beer” as used herein is defined by beer that has 0.5% to less than 1.2% alcohol by volume (ABV).

As used herein, the words “haze”, “cloudiness” and “turbidity” are used interchangeably. To quantify the amount of haze in a beverage, a turbidimeter can be used. In a turbiditimeter the amount of light is measured that is scattered at a prediscribed angle relative to the direction of the incident light beam. Turbidity measurements are very suitable for the measurement of haze formed as the result of protein-polyphenol interactions.

In an embodiment wort is prepared by providing cereals and subjecting them to a milling step. Cereals include, but are not limited to malt, barley, wheat, corn, rye, oat, rice, sorghum and cassave.

After the milling step, the cereals are subjected to a mashing step. Before mashing, the milled cereals may be subjected to a cooking step. In an embodiment, enzymes, such as endoglucanases, xylanases, proteases, alpha-amylases and amyloglucosidase, are used during mashing. The main objective of mashing is to convert the starch from the raw materials, e.g. cereals, into fermentable sugars. This is done in the mashing process and can be done in a single vessel (mash tun) or in a double vessel, a mash tun and a cereal cooker. Most of the times the second vessel, i.e. the cereal cooker, is used to liquefy grains that contain starch with high gelatinisation temperatures. After this cereal cooking process, this part of the mash is transferred back to the mash tun.

After the mashing step, the mash is filtered to prepare a wort. Wort may also be prepared by dissolving a malt extract in hot water.

In an embodiment the process for the prevention or reduction of haze in a beverage as described herein comprises the steps of (a) milling cereals to obtain milled cereals, (b) mashing the milled cereals to obtain a mash, (c) filtering the mash to prepare a wort, (d) adding a prolyl-specific endoprotease to the wort and incubating the wort, (e) boiling the wort, and (f) preparing the beverage from the wort.

In an embodiment the process for the prevention or reduction of haze in a beverage as described herein comprises the steps of (a) providing a malt extract, (b) dissolving the malt extract to prepare a wort, (c) adding a prolyl-specific endoprotease to the wort and incubating the wort, (e) boiling the wort, and (f) preparing the beverage from the wort.

Hops may be added before, during and/or after the incubation step. Hops may also be added before and/or during the boiling step.

In an embodiment the beverage can be prepared from the wort by subjecting the boiled wort to a separation step. After the separation step, the wort may be subjected to a fermentation step. Optionally, the fermentation step is preceded by a cooling step. After the fermentation step, the fermented wort may be subjected to a maturation step and/or a stabilization step. Thereafter, the obtained intermediate beverage may be subjected to a filtration step and/or a stabilization step to obtain the beverage. Thereafter, the beverage may be subjected to a pateurisation step.

A “fermentation step” as used herein is the step in preparing a beverage (e.g. beer brewing) intended to ferment available sugars into alcohol by the added yeasts.

In an embodiment the process for the prevention or reduction of haze in a beverage as described herein comprises the steps of (a) preparing a wort, (b) adding a prolyl-specific endoprotease to the wort and incubating the wort, (c) boiling the wort, (d) subjecting the boiled wort to a separation step, (e) optionally, cooling the wort or a part thereof, (f) fermenting the wort or part thereof, (g) maturing and/or stabilizing the fermented wort to obtain an intermediate beverage, (h) filtering and/or stabilizing the intermediate beverage to obtain the beverage, and (i) pasteurizing the beverage.

In an embodiment the process for the prevention or reduction of haze in a beverage as described herein comprises the steps of (a) milling cereals to obtain milled cereals, (b) mashing the milled cereals to obtain a mash, (c) filtering the mash to prepare a wort, (d) adding a prolyl-specific endoprotease to the wort and incubating the wort, (e) boiling the wort, (f) filtering the boiled wort, (g) optionally, cooling the filtered wort, (h) fermenting the filtered wort, (i) maturing and/or stabilizing the fermented wort to obtain an intermediate beverage, and (j) pasteurizing and/or filtering the intermediate beverage to obtain the beverage.

There exist several processes to produce alcohol-free and alcohol-low beers. They can for example be made by means of processes using dealcoholisation, dilution, limited fermentation (e.g. cold-contact fermentation), fermentation-free or any combination thereof.

With dealcoholisation, an alcoholic beer is brewed in the traditional way. The alcohol is then removed using a method such as steam distillation, water vapour or gas stripping, or reverse osmosis.

Using dilution to make alcohol-free beer, brewers produce a concentrated beer in the traditional way using a significant amount of hops and grains to create a concentrated beer high in flavour and body. After fermentation, they dilute the concentrated beer with water until the alcohol level is low, and then re-carbonate it.

There are three common ways to limit fermentation and brewers can use a mixture of these methods to achieve a beer with a low or zero alcohol content. Firstly, the amount of fermentable sugars in the wort can be limited. Brewers can do this by using grains that produce less fermentable sugars (such as rice or maize) or by using techniques that extract less fermentable sugars out of the grains at the mashing stage of the brewing process. Secondly, brewers can make use of special yeast strains that can only produce low amounts of alcohol or that are lacking the capability of fermenting certain types of sugar such as maltose and maltotriose. Thirdly, the fermentation process can be slowed down or stopped completely by for example by increasing or decreasing the temperature during fermentation. An example of the latter is cold-contact fermentation, wherein fermentation is done with a yeast at low temperature for a certain time period (e.g. 24 hours).

Non-fermented malt beverages can be made by means of processes that are fermentation-free.

In an embodiment the process for the prevention or reduction of haze in a beverage as described herein comprises a limited fermentation step. As described above, a “fermentation step” as used herein is the step in preparing a beverage (e.g. beer brewing) intended to ferment available sugars into alcohol by the added yeasts. As used herein, a “limited fermentation step” means that the fermentation step differs from the fermentation step for making an alcoholic beer. For example, the limited fermentation step may be shortened in time compared to the fermentation step for making an alcoholic beer or may be conducted at a very low temperature (e.g. cold-contact fermentation).

In an embodiment the process for the prevention or reduction of haze in a beverage as described herein comprises the steps of (a) preparing a wort, (b) adding a prolyl-specific endoprotease to the wort and incubating the wort, (c) boiling the wort, and (d) preparing the beverage from the wort, wherein the beverage is prepared from the wort by using a limited fermentation step.

In an embodiment the process for the prevention or reduction of haze in a beverage as described herein does not comprise a fermentation step.

In an embodiment the process for the prevention or reduction of haze in a beverage as described herein comprises the steps of (a) preparing a wort, (b) adding a prolyl-specific endoprotease to the wort and incubating the wort, (c) boiling the wort, and (d) preparing the beverage from the wort, wherein the beverage is prepared from the wort in the absence of a fermentation step. In an embodiment the process for the prevention or reduction of haze in an alcohol-free beer as described herein comprises the steps of (a) preparing a wort, (b) adding a prolyl-specific endoprotease to the wort and incubating the wort, (c) boiling the wort, and (d) preparing the alcohol-free beer from the wort, wherein the alcohol-free beer is prepared from the wort in the absence of a fermentation step.

In an embodiment the wort is incubated for 1 to 240 minutes at a temperature of 50° C. to 80° C.

In an embodiment the wort is incubated for 5 to 220 minutes. In an embodiment the wort is incubated for 10 to 200 minutes. In an embodiment the wort is incubated for 15 to 180 minutes. In an embodiment the wort is incubated for 20 to 160 minutes. In an embodiment the wort is incubated for 25 to 140 minutes. In an embodiment the wort is incubated for 30 to 120 minutes. In an embodiment the wort is incubated for 5 to 220 minutes.

In an embodiment the wort is incubated at a temperature of 50° C. to 85° C. In an embodiment the wort is incubated at a temperature of 55° C. to 80° C. In an embodiment the wort is incubated at a temperature of 60° C. to 75° C. Any combination incubation time and incubation temperature as given above is encompassed herein.

In an embodiment the wort is boiled for 45 to 120 minutes at a temperature of 95° C. to 100° C.

In an embodiment the prolyl-specific endoprotease is added in an amount of 1 to 100 g/hl wort. In an embodiment the prolyl-specific endoprotease is added in an amount of 2 to 90 g/hl wort. In an embodiment the prolyl-specific endoprotease is added in an amount of 3 to 80 g/hl wort. In an embodiment the prolyl-specific endoprotease is added in an amount of 4 to 70 g/hl wort. In an embodiment the prolyl-specific endoprotease is added in an amount of 5 to 60 g/hl wort.

Endoproteases having a prolyl-specific activity are known (E.C.3.4.21.26). A “prolyl-specific endoprotease” is defined as an endoprotease that cuts proteins or peptides near or at places where the protein or peptide contains a prolyltresidue in its chain. Preferably, a prolyl-specific endoprotease is an endoprotease that cuts proteins or peptides at places where the protein or peptide contains a prolyl-residue. In the method according to the invention, a prolyl-specific endoprotease is preferably used that cuts prolyl-residues at their C-terminus. In this text, the terms prolyl-specific endoprotease, proline-specific endoprotease, proline-specific endopeptidase and peptide having a prolyl-specific activity or similar expressions are used interchangeably.

A prolyl-specific endoprotease as used in the processes as described herein may be used in an isolated form. It will be understood that the prolyl-specific endoprotease may be mixed with carriers or diluents which will not interfere with the intended purpose of the prolyl-specific endoprotease and still be regarded as isolated. A prolyl-specific endoprotease may also be in a more substantially purified form, in which case it will generally comprise the polypeptide in a preparation in which more than 70%, e.g. more than 80%, 90%, 95%, 98% or 99% of the proteins in the preparation is a prolyl-specific endoprotease. A prolyl-specific endoprotease may be provided in a form such that it is outside its natural cellular environment. Thus, it may be substantially isolated or purified, as discussed above, or in a cell in which it does not occur in nature, for example a cell of another fungal species, an animal, a plant or a bacterium. Advantageously, isolated or purified prolyl-specific endoprotease is used in the processes as described herein. An isolated or purified prolyl-specific endoprotease preferably has at least 5 units of prolyl-specific endoprotease activity per gram of proteinaceous material. Prolyl-specific endoproteases are widely found in animals and plants, but their presence in microorganisms appears to be limited. Prolyl-specific endoprotease have been identified in species of Aspergillus, Flavobacterium, Aeromonas, Xanthomonas and Hacteroides. Though the prolyl-specific enzymes from most of these organisms are active around pH 8, the Aspergillus enzyme is optimally active around pH 5. The prolyl-specific endoprotease may be isolated from one of the above-mentioned microbial species, particularly from a species of Aspergillus. Preferably, the prolyl-specific endoprotease is isolated from a strain of Aspergillus niger. More preferably, the prolyl-specific endoprotease is isolated from an Aspergillus niger host engineered to overexpress a gene encoding a prolyl-specific endoprotease, although other hosts, such as E. coli are suitable expression hosts as well.

In an embodiment prolyl-specific endoproteases that can be used in the processes as described herein include the ones described in WO02/45524 (see SEQ ID NO:2), WO02/46381 (see SEQ ID NO:4, SEQ ID NO:5 and/or SEQ ID NO:7). A suitable prolyl-specific endoprotease that can be used in the processes as described herein includes Brewers Clarex® (DSM).

### EXAMPLES

### Example 1

### Use of Prolyl-Specific Endoprotease During Wort Incubation

A 12° Plato wort was made by adding spraymalt powder (Amber 18EBC, Muntons) to tap water. This wort was subsequently incubated after addition of 5 g/hl, 10 g/hl and 50 g/hl prolyl-specific endoprotease for 30 minutes, 60 minutes or 120 minutes at 60° C., 70° C. or 75° C.

A commercial sample of prolyl-specific endoprotease from A. niger, called Brewers Clarex®, was used. The activity of proline-specific endoprotease was measured on the synthetic peptide Z-Gly-Pro-pNA at 37° C. in a citrate/disodium phosphate buffer pH 4.6. The reaction products were monitored spectrophotometrically at 405 nm. One unit (1 PPU) is defined as the quantity of enzyme that liberates 1 μmol of p-nitroanilide per minute under these test conditions.

After the wort incubations, the wort was boiled for 30 minutes in the presence of hops (Hallertau hop pellets, Brewferm) dosed at 1 g/l and the trub separation was performed with a paper filter.

Fermentations with the boiled worts were started by the addition of 2.5 g/l pre-bloomed yeast (Saflager S-23, Fermentis) at 100 ml scale at 12° C. for 4 days.

For comparison purposes, the same 12° Plato wort was used without a wort incubation and with addition of the prolyl-specific endoprotease at 1 g/hl during fermentation. In detail, the 12° Plato wort made from the spraymalt powder (Amber 18EBC, Muntons) was boiled directly in presence of 1 g/l hop, followed by a hot trub separation over a paper filter. Fermentation of the boiled wort was started by the addition of 2.5 g/l pre-bloomed yeast (Saflager S-23, Fermentis) and the prolyl-specific endoprotease at 1 g/hl at 100 ml scale at 12° C. for 4 days.

The fermentation performance was monitored by monitoring fermentation gas production. Fermentation gas production was monitored using ANKOM RF Gas Production System (Ankom Technology), logging cumulative pressure measurements over time.

After fermentation, a cold rest of one day at 0° C. was performed. Subsequently, the fermentation broth was centrifuged for 10 minutes, at 14000 rcf, at 20° C. to obtain a solid-liquid separation. The supernatant was analyzed for the presence of haze active proteins via a tannic acid titration (HSP10).

Haze active proteins were measured with a Tannometer using the Pfeuffer operating instructions for this method. Tannic acid was added to the samples and the haze measured at 20° C. under 90 degrees scatter angle expressed in EBC units and reported for the addition of 2.5, 5 and 10 mg/I tannic acid.

The results are shown in Table 1. They show that the amount of haze active proteins is lower when applying prolyl-specific endoprotease in a wort incubation before wort boiling compared to applying prolyl-specific endoprotease during fermentation.

### Example 2

### Use of Prolyl-Specific Endoprotease During Wort Incubation

A 12°Plato wort was made by adding spraymalt powder (Amber 18EBC, Muntons) to tap water. This wort was subsequently incubated after addition of 5 g/hl, 10 g/hl, 25 g/hl and 50 g/hl prolyl-specific endoprotease for 30 minutes, 60 minutes, 90 minutes or 120 minutes at 60° C. or 70° C.

A commercial sample of prolyl-specific endoprotease from A. niger, Brewers Clarex® (5 PPU/g product) as described in Example 1 was used.

After the wort incubations, the wort was boiled for 30 minutes in the presence of hops (Hallertau hop pellets, Brewferm) dosed at 1 g/l and the trub separation was performed with a paper filter.

Fermentations with the boiled worts were started by the addition of 2.5 g/l pre-bloomed yeast (Saflager S-23, Fermentis) at 100 ml scale at 12° C. for 4 days.

For comparison purposes, the same 12°Plato wort was used without a wort incubation and with addition of the prolyl-specific endoprotease at 2 g/hl during fermentation. In detail, the 12°Plato wort made from the spraymalt powder (Amber 18EBC, Muntons) was boiled directly in presence of 1 g/l hop, followed by a hot trub separation over a paper filter. Fermentation of the boiled wort was started by the addition of 2.5 g/l pre-bloomed yeast (Saflager S-23, Fermentis) and the prolyl-specific endoprotease at 2 g/hl at 100 ml scale at 12° C. for 4 days.

The fermentation performance was monitored by monitoring fermentation gas production as described in Example 1.

After fermentation, a cold rest of one day at 0° C. was performed. Subsequently, the fermentation broth was centrifuged for 10 minutes, at 14000 rcf, at 20° C. to obtain a solid-liquid separation. The supernatant was analyzed for the presence of haze active proteins via a tannic acid titration (HSP10) as described in Example 1.

The results are shown in Table 2. They show that the amount of haze active proteins is lower when applying prolyl-specific endoprotease in a wort incubation before wort boiling compared to applying prolyl-specific endoprotease during fermentation.

TABLE 1
Haze active protein content in supernatants from wort fermentations, where
the wort was incubated under different conditions (varying prolyl-specific
endoprotease dosage, time and temperature) versus a control where the
prolyl-specific endoprotease was added to the fermentation.

| | Application of | | | | |
|---|---|---|---|---|---|
| | prolyl-specific | Enzyme dosage | Temperature | Incubation time | HSP10 |
| Sample | endoprotease | (in g/hl) | (in ° C.) | (in minutes) | (EBC) |
| 1 | Fermentation | 1 | 12 | 5760 | 3.59 |
| 2 | Wort incubation | 5 | 60 | 120 | 3.50 |
| 3 | Wort incubation | 10 | 70 | 30 | 3.43 |
| 4 | Wort incubation | 50 | 75 | 30 | 3.19 |
| 5 | Wort incubation | 50 | 75 | 60 | 3.40 |

TABLE 2
Haze active protein content in supernatants from wort fermentations, where
the wort was incubated under different conditions (varying prolyl-specific
endoprotease dosage, time and temperature) versus a control where the
prolyl-specific endoprotease was added to the fermentation.

| | Application of | | | | |
|---|---|---|---|---|---|
| | prolyl-specific | Enzyme dosage | Temperature | Incubation time | HSP10 |
| Sample | endoprotease | (in g/hl) | (in ° C.) | (in minutes) | (EBC) |
| 1 | Fermentation | 2 | 12 | 5760 | 3.19 |
| 2 | Wort incubation | 10 | 60 | 120 | 3.16 |
| 3 | Wort incubation | 10 | 70 | 60 | 3.11 |
| 4 | Wort incubation | 10 | 70 | 90 | 3.06 |
| 5 | Wort incubation | 25 | 60 | 120 | 3.16 |
| 6 | Wort incubation | 25 | 60 | 30 | 2.88 |
| 7 | Wort incubation | 25 | 70 | 30 | 2.54 |
| 8 | Wort incubation | 25 | 70 | 60 | 2.51 |
| 9 | Wort incubation | 25 | 70 | 90 | 2.47 |
| 10 | Wort incubation | 50 | 70 | 30 | 2.13 |
| 11 | Wort incubation | 50 | 70 | 60 | 2.46 |
| 12 | Wort incubation | 50 | 70 | 90 | 2.34 |

1. A process for prevention or reduction of haze in a beverage, the process comprising:
a) preparing a wort,
b) adding a prolyl-specific endoprotease to the wort and incubating the wort,
c) boiling the wort, and
d) preparing the beverage from the wort; wherein the beverage is an alcohol-free beer having less than 0.5% alcohol by volume or an alcohol-low beer having an alcohol content of from 0.5% to 1.2% alcohol by volume.

2. The process according to claim 1, wherein the prolyl-specific endoprotease is added in an amount of 1 to 100 g/hl wort.

3. The process according to claim 1, wherein the wort is incubated for 1 to 240 minutes at a temperature of 50° C. to 85° C.

4. The process according to claim 1, wherein the wort is boiled for 45 to 120 minutes at a temperature of 95° C. to 100° C.

5. The process according to claim 1, wherein the process does not comprise fermentation.

6. The process according to claim 1, wherein the process comprises limited fermentation.

7. The process according to claim 6, wherein the limited fermentation comprises a shortened time compared to fermentation for making an alcoholic beer or may be conducted at a very low temperature.

8. A process for prevention or reduction of haze in a beverage comprising:
a) providing a malt extract,
b) dissolving the malt extract to prepare a wort,
c) adding a prolyl-specific endoprotease to the wort,
d) incubating the wort,
e) boiling the wort, and
f) preparing the beverage from the wort.
